(19) United States
(12) Patent Application Publication
(10) Pub. No.: US 2018/0150790 A1
(43) Pub. Date: May 31, 2018

(54) PACKAGING ENVIRONMENT

(71) Applicant: Wal-Mart Stores, Inc., Bentonville, AR (US)

(72) Inventors: Richard A. White, Pineville, MO (US); Taylor R. Davis, Rogers, AR (US); Louis B. Page, Sunnyvale, CA (US)

(21) Appl. No.: 15/824,899

(22) Filed: Nov. 28, 2017

Related U.S. Application Data
(60) Provisional application No. 62/426,922, filed on Nov. 28, 2016.

(51) Int. Cl. G06Q 10/08; H01Q 1/22

(52) U.S. Cl. CPC G06Q 10/087; G01F 23/68; H01Q 1/2208

(57) ABSTRACT

One or more open packing containers are entered into a packing environment (that may utilize one or more conveyor belts to move such packing containers). The container includes a wireless communications interface (such as an RFID tag) that transmits a unique identifier. Upon detecting that an item has been placed in the container, a determination is made as to whether the corresponding order is complete. When true, the container corresponding to the order is automatically exited from the packing environment. When other items of the order still remain to be packed, these teachings provide for automatically determining whether any additional such items for this order can be placed in this particular open packing container. When true, this particular open packing container is retained within the packing environment. Otherwise, this particular open packing container is removed from the packing environment notwithstanding that the order is not yet complete.

### CROSS-REFERENCE TO RELATED APPLICATION

This application claims the benefit of U.S. Provisional Application No. 62/426,922, filed Nov. 28, 2016, and is incorporated herein by reference in its entirety.

### TECHNICAL FIELD

These teachings relate generally to order fulfillment and more particularly to the efficient and correct use of packing containers.

### BACKGROUND

In a modern retail store environment, there is a need to improve the customer experience and/or convenience for the customer. With increasing competition from non-traditional shopping mechanisms, such as online shopping provided by e-commerce merchants and alternative store formats, it can be important for “bricks and mortar” retailers to focus on improving the overall customer experience and/or convenience.

By one approach improving the customer's experience can include helping the customer to avoid some visits to a retail shopping facility by shipping ordered products directly to the customer. Using this approach can provide the customer with access to a considerably greater number of products than are typically offered in a modern retail shopping facility.

Unfortunately, customer orders can vary greatly with respect to the particular items that are ordered and the relative quantities of such items. This necessarily means that ordered items can assume any of a wide variety of shapes and sizes as well as weights. It is also possible that some items are not advisedly packed in tandem with one another in a shared container. These real-life circumstances give rise to any number of practical challenges as regards packing the various contents of a given order. In particular, these challenges can include minimizing the number and/or size of the containers employed, minimizing cognitive challenges for packing associates, and avoiding inappropriate combinations of items within a single container, to note but a few.

### BRIEF DESCRIPTION OF THE DRAWINGS

The above needs are at least partially met through provision of the packing environment described in the following detailed description, particularly when studied in conjunction with the drawings, wherein:

FIG. 1 comprises a block diagram as configured in accordance with various embodiments of these teachings; and

FIG. 2 comprises a flow diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, these teachings provide for entering one or more open packing containers (such as open cardboard boxes) into a packing environment. By one approach this packing environment utilizes one or more conveyor belts to move packing containers within the packing environment. The open packing container includes a wireless communications interface (such as a passive radio-frequency identification (RFID) tag) that transmits a unique identifier for the corresponding open packing container. Per these teachings this one or more open packing container is assigned for use in shipping a particular order to a particular recipient.

Upon detecting that an item has been placed in such a container, these teachings provide for determining whether the corresponding order is complete. When true, the one or more open packing containers corresponding to this order are automatically exited from the packing environment. When other items of the order still remain to be packed, however, these teachings provide for automatically determining whether any additional such items for this order can be placed in this particular open packing container. When true, this particular open packing container is retained within the packing environment to accommodate placement of at least one additional item therein. Otherwise, this particular open packing container is removed from the packing environment notwithstanding that the order is not yet complete.

By one approach, the packing environment includes one or more automated gates by which the open packing container can be moved and routed within the packing environment.

These teachings are highly flexible in practice. By one approach, for example, these teachings will accommodate making the aforementioned automatic determination regarding whether any additional items for a particular order can be placed in the aforementioned open packing container as a function, at least in part, of the remaining volume in a currently-used open packing container and/or a remaining weight capacity of this open packing container. As another example of flexibility, these teachings will also accommodate, upon detecting that an item has been placed in an open packing container with another item, determining whether that combination of items constitutes a prohibited combination of items. When true, these teachings will accommodate automatically responding with a curative action.

So configured, these teachings can greatly facilitate the use of a large packing environment to facilitate packing smaller orders including direct-to-customer orders and smaller multi-customer consolidated orders that are shipped to a retail shopping facility for customer pickup. In particular, these teachings permit packing personnel to remain focused on picking and placing particular items without necessarily needing to also consider and determine whether a particular item should be placed in one box for a particular order or in another box that may pertain to that order. Generally speaking, the various approaches taught herein can achieve reduced packing times and more efficient use of costly packing materials to thereby provide customers with their ordered items more quickly and at a lower cost.

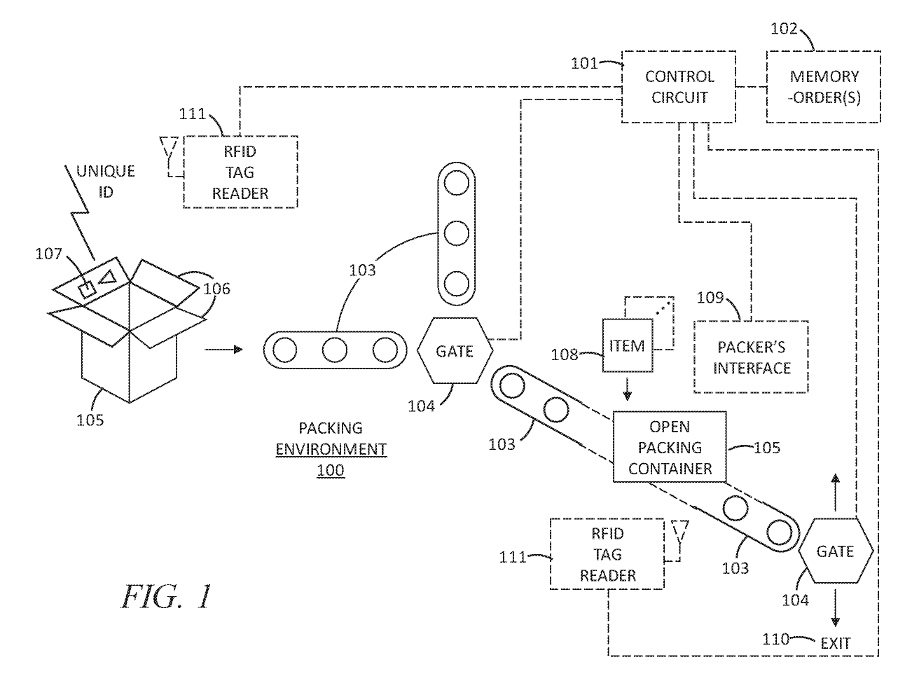

These and other benefits may become clearer upon making a thorough review and study of the following detailed description. Referring now to the drawings, and in particular to FIG. 1, an illustrative application setting that is compatible with many of these teachings will now be presented. In this particular illustrative example the application setting comprises a distribution center.

As used herein the expression “distribution center” will be understood to refer to a physical facility (such as one or more buildings) where goods are received post-manufacture and then further distributed to a plurality of retail shopping facilities. A distribution center is not itself a retail shopping facility and instead serves as part of the supply chain that supplies retail shopping facilities with products to be sold at retail. A distribution center can serve as a warehouse by temporarily storing received items pending the distribution of such items to retail shopping facilities but in many cases products will not be warehoused in a traditional sense and will instead be moved from a receiving area to a dispersal area to minimize the time during which the distribution center possesses such items. In a typical application setting the distribution center and the corresponding retail shopping facilities will be co-owned/operated by a same enterprise.

FIG. 1 in particular presents a packing environment 100 that comprises a part of the distribution center. In this particular example, the enabling apparatus includes a control circuit 101. Being a “circuit,” the control circuit 101 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 101 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 101 is configured (for example, by using corresponding programming as will be well understood by those skilled in the art) to carry out one or more of the steps, actions, and/or functions described herein.

The control circuit 101 operably couples to a memory 102. This memory 102 may be integral to the control circuit 101 or can be physically discrete (in whole or in part) from the control circuit 101 as desired. This memory 102 can also be local with respect to the control circuit 101 (where, for example, both share a common circuit board, chassis, power supply, and/or housing) or can be partially or wholly remote with respect to the control circuit 101 (where, for example, the memory 102 is physically located in another facility, metropolitan area, or even country as compared to the control circuit 101).

In addition to information regarding customer orders, this memory 102 can serve, for example, to non-transitorily store the computer instructions that, when executed by the control circuit 101, cause the control circuit 101 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

By one optional approach the control circuit 101 operably couples to a user interface (not shown). Such a user interface can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user.

If desired, and by another optional approach, the control circuit 101 can also operably couple to a network interface (not shown). So configured the control circuit 101 can communicate with other elements (both within the packing environment 100 and/or external thereto) via such a network interface. Network interfaces, including both wireless and non-wireless platforms, are well understood in the art and require no particular elaboration here.

In this example the packing environment 100 includes at least one conveyor belt, and in a typical application setting a plurality of conveyor belts (denoted in FIG. 1 by reference numeral 103). Conveyor belts are well understood in the prior art and the present teachings are not overly sensitive to any particular selections in these regards. That said, in many useful application settings at least some of the conveyor belts will be automated and employ electric motors to cause the belt to move and thereby transport items supported thereby. These conveyor belts may be as short or as long as befits the application setting and may be horizontal or inclined as appropriate. (If desired, the operating state of one or more of these conveyor belts 103 can be controlled, at least in part, by the aforementioned control circuit 101.)

In this illustrative example the packing environment 100 also includes at least one automated gate (with two such automated gates being shown in FIG. 1 and denoted by reference numeral 104). Conveyor belt automated gates are also known in the art and again the present teachings are not overly sensitive to any particular selections in these regards. Generally speaking, such a gate serves to selectively direct items being transported on a first conveyor belt between at least one of two alternative directions. As one simple example, an automated gate can serve to either permit an item to continue moving along that first conveyor belt or to be diverted from that first conveyor belt onto, for example, a second conveyor belt. By one approach, and as suggested by FIG. 1, these automated gates 104 can be operably coupled to and controlled by the aforementioned control circuit 101.

So configured, open packing containers can be moved within the packing environment 100 to thereby deliver such containers to locations within the packing environment 100 where items can be placed in such containers to facilitate shipment of such items. Other selected details regarding the packing environment 100 are provided herein where and as appropriate to this description.

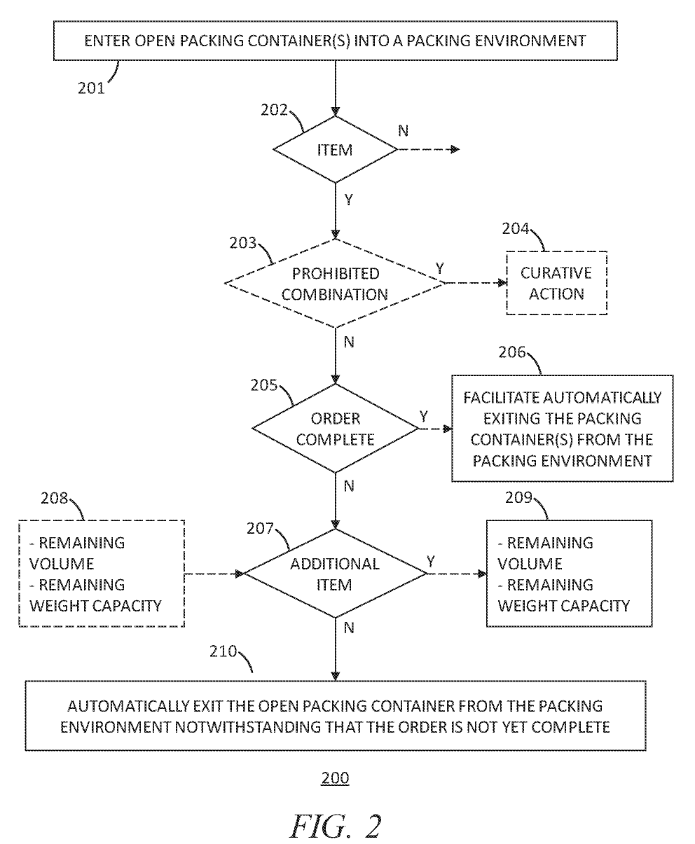

Referring now to both FIG. 1 and FIG. 2, FIG. 2 describes a process 200 that can be carried out with respect to such a packing environment 100. In many cases some or all of the described decisions and responses of this process 200 can be carried out by the aforementioned control circuit 101.

At block 201, this process 200 provides for entering at least a first open packing container 105 into the packing environment 100. For the sake of an illustrative example it will be presumed here that this open packing container 105 comprises a cardboard box whose closure flaps 106 are presently opened. It will be understood, however, that these teachings will readily accommodate open packing containers comprised of other materials and/or having other form factors and designs.

In this example the open packing container 105 includes a wireless communications interface. Again for the sake of a specific example it will be presumed here that the wireless communications interface comprises a radio-frequency identification (RFID) tag 107 (comprising, as appropriate, a near-field or a far-field component as desired). That said, those skilled in the art will understand and appreciate that other technologies could be similarly employed to serve as a wireless communications interface. In many application settings it will be useful for the open packing container 105 to include the wireless communications interface prior to when the open packing container 105 enters the packing environment 100. These teachings will accommodate other approaches, however. For example, the wireless communications interface can be attached to a given open packing container after the open packing container has entered the packing environment 100 and before the open packing container exits the packing environment 100.

Also in this example it will be presumed that the wireless communications interface is configured to transmit a unique identifier (where the identifier is at least “unique” within the context of the packing environment 100). For example, when the wireless communications interface comprises an RFID tag, the RFID tag's data can include an identifier that is unique to that particular responding RFID tag. The Electronic Product Code (EPC) as managed by EPCGlobal, Inc., for example, represents one such effort in these regards. EPC-based RFID tags each have an utterly unique serial number (within the EPC system) to thereby uniquely identify each tag and, by association, each item associated on a one-for-one basis with such tags. (The corresponding document entitled EPC Radio-Frequency Identity Protocols Class-1 Generation-2 UHF RFID Protocol for Communications at 860 MHz-960 MHz Version 1.0.9 (often referred to as “EPC GEN2”) is hereby fully incorporated herein by this reference.) Since the wireless communications interface is secured to the open packing container 105, that unique identifier is therefore also correlated to that open packing container 105.

With the foregoing in mind, the packing environment 100 can optionally include one or more RFID tag readers 111 that are configured to compatibly read such an RFID tag 107. By appropriate placement of these RFID tag readers 111, movement and/or present location of a given open packing container 105 within the packing environment 100 can be reliably tracked.

In a typical application setting the open packing container(s) 105 is assigned for use in shipping an order to a particular recipient (such as a customer). By one approach this correlation between the open packing container(s) and a particular order occurs before the open packing container enters the packing environment 100. By another approach, in lieu of the foregoing or in possible combination therewith, at least some open packing containers may enter the packing environment 100 before any particular order is associated therewith (in which case such an open packing container will be correlated with a particular order after having entered the packing environment 100).

As already noted above, this process 200 will accommodate entering more than one open packing container 105 into the packing environment 100. As one simple example in these regards, both a first and a second open packing container may be entered into the packing environment 100 where both of these containers are assigned for use in shipping a single multi-item order to a particular recipient.

In a typical application setting, at least a part of entering the open packing container 105 into the packing environment 100 comprises placing that open packing container 105 (or containers) onto a conveyor belt 103. The conveyor belt system can then move the open packing container 105 to various locations within the packing environment 100 where ordered items can be placed therein. FIG. 1 offers an illustrative example in these regards where at least one item 108 (and other items as comprise a part of the corresponding order) are placed into the open packing container 105. Those skilled in the art will understand that the item 108 may be placed in the open packing container 105 by way of a human packer or an automated packer as desired.

At block 202, this process 200 provides for detecting when an item 108 is placed in the open packing container 105. By one approach this detection can be based upon one or more sensors (not shown) by which the control circuit 101 can reliably detect this event. Exemplary sensors in these regards include but are not limited to weight sensors, light-based sensors, laser-based sensors, image processing-sensors, and so forth. By another approach, the packer may utilize an available packer's interface 109 (such as a touch-screen computer display or other user interface) to enter information that directly or indirectly corresponds to the placement of the item 108 in the open packing container 105.

In the absence of detecting such an event this process 200 can accommodate any of a variety of responses. Examples of responses can include temporal multitasking (pursuant to which the control circuit 101 conducts other tasks before returning to again monitor for this event) as well as continually looping back to essentially continuously monitor for the trigger event(s). These teachings also accommodate supporting this detection activity via a real-time interrupt capability if desired.

Upon detecting that an item 108 has been placed in the open packing container 105 at detection block 202, by one optional approach and as illustrated at block 203 this process 200 will accommodate determining whether a prohibited combination of items are now present in the open packing container 105. A particular combination of items may be “prohibited” for a variety of reasons, including legal reasons, shipping logistics reasons, weight limitations, customer preferences, and so forth, to note but a few possibilities in these regards. Upon detecting a prohibited combination, at block 204 this process 200 will accommodate automatically responding with a curative action.

As one example in these regards, the curative action can comprise providing an alert (such as an audible or visual alert) to, for example, an authorized recipient. As one simple example, an alert may be provided via the aforementioned packer's interface 109. In this case, such an alert can help alert the packer that a just-placed item in the open packing container presents a concern and the packer may then take an appropriate corresponding action, such as removing one or both of the prohibited combination of items.

As another example in these regards, the curative action may comprise automatically directing (via, for example, one of the aforementioned automated gates 104) the open packing container (or containers) that contains the prohibited combination to a curative area. The curative area may comprise, for example, an area in the packing environment 100 where associates are available to assess and or otherwise deal with and correct (or possibly override and approve) the combination-based point of concern.

At block 205 this process 200 provides for determining whether the order is now complete following the placement of the detected item 108 in the open packing container 105. In particular, this inquiry provides for determining whether all of the items that constitute this particular order are now in a packing container. When true, at block 206 this process 200 provides for facilitating automatically exiting the open packing container from the packing environment 100 to thereby make the container available for delivery per the customer's instructions. The foregoing may comprise, for example, using one or more of the automated gates 104 to ultimately deliver the container to the aforementioned exit 110.

Upon determining, however, that the order is not yet complete, at block 207 this process 200 provides for automatically determining whether any additional items 108 for the order can be placed in this particular open packing container 105. This determination can be based, for example, upon information 208 such as, but not limited to, information regarding a remaining volume in this particular open packing container and/or a remaining weight capacity of this particular open packing container.

When the foregoing determination indicates that this open packing container in fact can receive one or more additional items comprising a part of the order, and as illustrated at block 209, this process 200 can provide for retaining this particular open packing container within the packing environment 100 to permit placement of at least one additional item from the order therein. By one approach, if desired, this process will also accommodate purposefully and automatically rerouting this particular open packing container to another location within the packing environment 100 where that additional item or items can be picked and packed therein.

When the foregoing determination indicates that this open packing container is not suitable to receive one or more additional items comprising a part of the order, however, and as illustrated at block 210, this process 200 can provide for automatically exiting this open packing container from the packing environment 100 notwithstanding that the order is not yet complete. In a typical application setting one or more other open packing containers will be utilized to receive the remaining items that comprise the order to thereby conclude the packing activity in fulfillment of that order.

So configured, such an approach can help to assure efficient as well as appropriate use of one or more packing containers when fulfilling a particular customer. In particular, these teachings can help to minimize packing activity cycle time while assuring corresponding quality control measures in these regards.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A method comprising:
entering at least a first open packing container into a packing environment, the first open packing container having a wireless communications interface that transmits a unique identifier for the first open packing container and the first open packing container having been assigned for use in shipping an order to a particular recipient;
detecting when an item has been placed in the first open packing container;
when the order is complete, facilitating automatically exiting the first open packing container from the packing environment;
when the order is not yet complete, automatically determining whether any additional items for the order can be placed in the first open packing container and, when true, retaining the first open packing container within the packing environment to permit a placement of at least one additional item therein.

2. The method of claim 1 wherein entering at least the first open packing container into the packing environment comprises placing the first open packing container onto a conveyor belt.

3. The method of claim 1 wherein the first open packing container comprises a cardboard box.

4. The method of claim 1 wherein the wireless communications interface comprises a passive radio-frequency identification (RFID) tag.

5. The method of claim 1 wherein detecting when the item has been placed in the first open packing container comprises receiving an input via a packer's interface.

6. The method of claim 1 wherein facilitating automatically exiting the first open packing container from the packing environment comprises authorizing the first open packing container to be removed from the packing environment via an automated gate.

7. The method of claim 1 wherein when automatically determining whether any additional items for the order can be placed in the first open packing container yields a negative result, facilitating automatically exiting the first open packing container from the packing environment notwithstanding that the order is not yet complete.

8. The method of claim 1 wherein automatically determining whether any additional items for the order can be placed in the first open packing container comprises automatically determining whether any additional items for the order can be placed in the first open packing container as a function of at least one of a remaining volume in the first open packing container and a remaining weight capacity of the first open packing container.

9. A method comprising:
entering at least a first and a second open packing container into a packing environment, the first and second open packing container each having a wireless communications interface that transmits a corresponding unique identifier and both the first and second open packing container having been assigned for use in shipping an order to a particular recipient;
detecting when an item has been placed in either of the first and second open packing containers;
upon detecting that the item has been placed in one of the first and second open packing container, determining whether the order is complete;
when the order is complete, facilitating automatically exiting both the first and second open packing container from the packing environment;
when the order is not yet complete, automatically determining whether any additional items for the order can be placed in the open packing container that received the item and, when true, retaining the open packing container that received the item within the packing environment to permit a placement of at least one additional item therein.

10. The method of claim 9 wherein entering at least the first and second open packing containers into the packing environment comprises placing the first and second open packing containers onto a conveyor belt.

11. The method of claim 9 wherein the first and second open packing containers comprise cardboard boxes.

12. The method of claim 9 wherein the wireless communications interface comprises a passive radio-frequency identification (RFID) tag.

13. The method of claim 9 wherein detecting when an item has been placed in either of the first and second open packing containers comprises receiving an input via a packer's interface.

14. The method of claim 9 wherein facilitating automatically exiting both the first and second open packing container from the packing environment comprises authorizing automated removal of the first and second open packing containers from the packing environment via an automated gate.

15. The method of claim 9 wherein when automatically determining whether any additional items for the order can be placed in the open packing container that received the item yields a negative result, facilitating automatically exiting the open packing container that received the item from the packing environment notwithstanding that the order is not yet complete.

16. The method of claim 9 wherein automatically determining whether any additional items for the order can be placed in the open packing container the first open packing container that received the item comprises automatically determining whether any additional items for the order can be placed in the open packing container that received the item as a function of at least one of a remaining volume in the open packing container that received the item and a remaining weight capacity of the open packing container that received the item.

17. The method of claim 9 further comprising:
upon detecting that the item has been placed in one of the first and second open packing containers, determining whether a prohibited combination of items are now present in the one of the first and second open packing containers, and when true, automatically responding with a curative action.

18. The method of claim 17 wherein the curative action comprises providing an alert.

19. The method of claim 17 wherein the curative action comprises facilitating automatically directing the one of the first and second open packing containers that contains the prohibited combination to a curative area.
